(19) United States
(12) Patent Application Publication
(10) Pub. No.: US 2025/0028978 A1
(43) Pub. Date: Jan. 23, 2025

(54) Autocontrastive Decoding Among Model Layers

(71) Applicant: International Business Machines Corporation, Armonk, NY (US)

(72) Inventors: Ariel Gera, Tel Aviv (IL); RONI FRIEDMAN-MELAMED, Rehovot (IL); Ofir Arviv, HaSharom (IL); Benjamin Sznajder, Jerusalem (IL); Chulaka Gunasekara, New Hyde Park, NY (US); Eyal Shnarch, Tel Aviv (IL); Noam Slonim, London (GB)

(21) Appl. No.: 18/224,497

(22) Filed: Jul. 20, 2023

(51) Int. Cl. G06N 5/022

(52) U.S. Cl. CPC G06N 5/022

(57) ABSTRACT

Techniques for autocontrastive decoding of a machine learning model are provided. In one aspect, a system for machine learning includes: a multi-layer machine learning model; and an autocontrastive decoding module configured to obtain prediction probabilities from multiple, different layers of the multi-layer machine learning model as data propagates through the multi-layer machine learning model, and aggregate in a contrastive manner the prediction probabilities from the multiple, different layers of the multi-layer machine learning model to provide a final output from the multi-layer machine learning model. The multi-layer machine learning model can be a transformer-based machine learning model. The autocontrastive decoding module can be configured to redistribute a prediction probability distribution of the transformer-based machine learning model by maximizing a difference between log-probabilities of a final layer and one or more intermediate layers of the transformer-based machine learning model. A machine learning method using the present system is also provided.

### STATEMENT REGARDING PRIOR DISCLOSURES BY THE INVENTOR OR A JOINT INVENTOR

The following disclosure(s) are submitted under 35 U.S.C. 102(b)(1)(A): DISCLOSURE(S):

“The Benefits of Bad Advice: Autocontrastive Decoding across Model Layers,” Ariel Gera, Roni Friedman, Ofir Arviv, Chulaka Gunasckara. Benjamin Sznajder, Noam Slonim, Eyal Shnarch, arXiv: 2305.01628v1 (May 2, 2023) (13 pages).

“The Benefits of Bad Advice: Autocontrastive Decoding across Model Layers,” Ariel Gera, Roni Friedman, Ofir Arviv, Chulaka Gunasekara, Benjamin Sznajder, Noam Slonim, Eyal Shnarch, presented at the 61st Annual Meeting of the Association for Computational Linguistics (ACL 2023), Toronto, Canada, Jul. 9-14, 2023.

### FIELD OF THE INVENTION

The present invention relates to machine learning, and more particularly, to techniques for autocontrastive decoding of outputs from multiple, different layers of a machine learning model in order to improve model predictions.

### BACKGROUND OF THE INVENTION

Machine learning models can be employed for a variety of different tasks such as classification and natural language processing. For instance, a transformer-based language model can take as input a sequence of words, and predict what the next word in that sequence might be in order to form a grammatically and semantically correct sentence.

Data input to a machine learning model typically passes through multiple layers of the model, where computations are performed that tune predictions. For most applications, it is the output from the final layer of the machine learning model that is used for downstream tasks, such as making word predictions.

Doing so, however, overlooks recent findings that some of the representational knowledge required for performing such downstream tasks can already be found within intermediate layers of the machine learning model. For instance, the feed-forward layers in a transformer-based language model have been found to act as pattern detectors over input data across all layers.

Therefore, techniques for leveraging intermediate machine learning model output in a meaningful way to enhance performance would be desirable.

### SUMMARY OF THE INVENTION

The present invention provides techniques for autocontrastive decoding of outputs from multiple, different layers of a machine learning model in order to improve model predictions. In one aspect of the invention, a system for machine learning is provided. The system includes: a multi-layer machine learning model; and an autocontrastive decoding module configured to obtain prediction probabilities from multiple, different layers of the multi-layer machine learning model as data propagates through the multi-layer machine learning model, and aggregate in a contrastive manner the prediction probabilities from the multiple, different layers of the multi-layer machine learning model to provide a final output from the multi-layer machine learning model.

In another aspect of the invention, another system for machine learning is provided. The system includes: a transformer-based machine learning model; and an autocontrastive decoding module configured to redistribute a prediction probability distribution of the transformer-based machine learning model by maximizing a difference between log-probabilities of a final layer and one or more intermediate layers of the transformer-based machine learning model.

In yet another aspect of the invention, a machine learning method is provided. The machine learning method includes: providing data as input to a multi-layer machine learning model: obtaining prediction probabilities from multiple, different layers of the multi-layer machine learning model as the data propagates through the multi-layer machine learning model; and aggregating in a contrastive manner the prediction probabilities from the multiple, different layers of the multi-layer machine learning model to provide a final output from the multi-layer machine learning model.

A more complete understanding of the present invention, as well as further features and advantages of the present invention, will be obtained by reference to the following detailed description and drawings.

### BRIEF DESCRIPTION OF THE DRAWINGS

FIG. 1 is a diagram illustrating an exemplary computing environment according to an embodiment of the present invention;

FIG. 2 is a diagram illustrating an exemplary autocontrastive decoding system for machine learning according to an embodiment of the present invention;

FIG. 3 is a diagram illustrating an exemplary neural network according to an embodiment of the present invention;

FIG. 4 is a diagram illustrating an exemplary methodology for machine learning performed using the present autocontrastive decoding system according to an embodiment of the present invention;

FIG. 5 is a diagram illustrating an exemplary configuration of the present autocontrastive decoding system implementing a transformer-based machine learning model according to an embodiment of the present invention;

FIG. 6 is a diagram illustrating results of open-ended text generation using different decoding strategies according to an embodiment of the present invention;

FIG. 7 is a diagram illustrating results of open-ended text generation for a smaller model using different decoding strategies according to an embodiment of the present invention;

FIG. 8 is a table displaying results of open-ended generation outputs over a corpus for a large model, a medium-sized model, and the medium-sized model applying autocontrastive decoding at inference time according to an embodiment of the present invention;

FIG. 9A is a plot displaying evaluation results comparing greedy decoding generation outputs of the large model and the medium-sized model, and FIG. 9B is a plot displaying evaluation results comparing greedy decoding generation outputs of the large model and the medium-sized model applying autocontrastive decoding according to an embodiment of the present invention;

FIG. 10A is a plot displaying generation coherence for different model exits, and FIG. 10B is a plot displaying n-gram textual diversity of open-ended generation across layers according to an embodiment of the present invention;

FIG. 11A is a plot displaying accuracy on a benchmark dataset for the medium-sized model, and FIG. 11B is a plot displaying perplexity on the benchmark dataset for the medium-sized model according to an embodiment of the present invention;

FIG. 12A is a plot displaying accuracy on a benchmark dataset for a smaller model, and FIG. 12B is a plot displaying perplexity on the benchmark dataset for the smaller model according to an embodiment of the present invention;

FIG. 13 is a table displaying scale effects of autocontrastive decoding on the benchmark dataset according to an embodiment of the present invention; and

FIG. 14 is a plot displaying word-level perplexity over a general corpus according to an embodiment of the present invention.

### DETAILED DESCRIPTION OF PREFERRED EMBODIMENTS

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

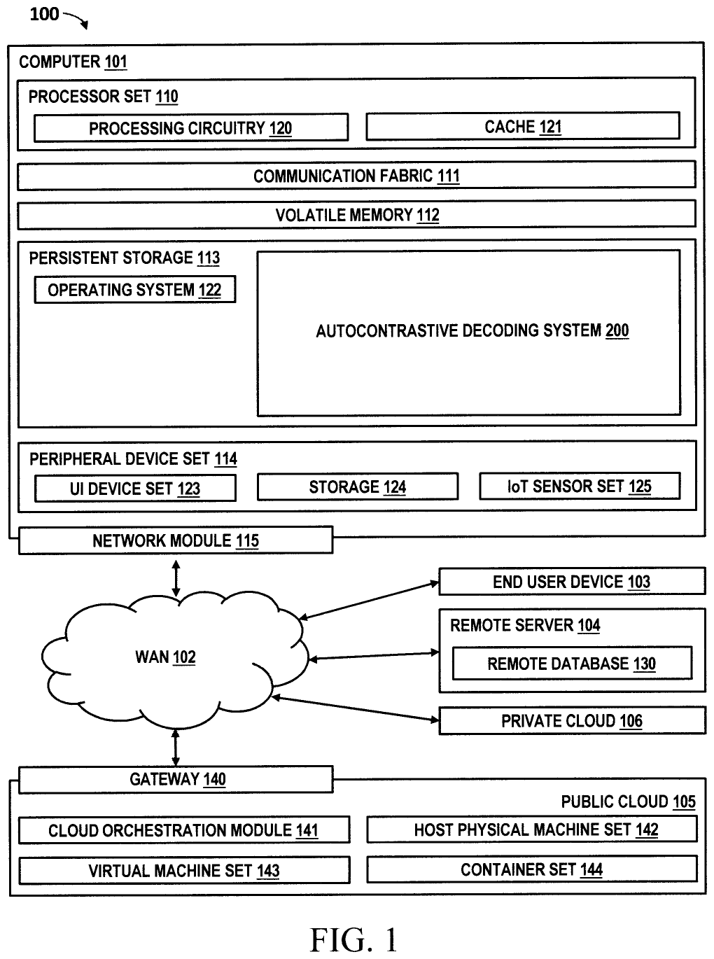

Referring to FIG. 1. computing environment 100 contains an example of an environment for the execution of at least some of the computer code involved in performing the inventive methods, such as autocontrastive decoding system 200 for machine learning. In addition to system 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and system 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in system 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in system 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As provided above, conventional approaches to machine learning often overlook the knowledge that can be gleaned from the intermediate layers of a machine learning model, as they seek only the final layer output. Advantageously, it has been found herein that contrasting the output from multiple, different layers of a machine learning model during inference improves the model predictions. This process is referred to herein as autocontrastive decoding. Since the layers are part of the same machine learning model, with the present approach the model is essentially being contrasted with itself, hence performing an ‘auto-contrast’ as in ‘self-contrast.’

Namely, as will be described in detail below, the present autocontrastive decoding approach involves combining and contrasting the output obtained by passing input data through a fewer number of the model layers (e.g., from one or more of the intermediate layers) with that output obtained by passing the input data through a larger number of the model layers (e.g., propagating the data through all of the layers until a final layer of the model). This approach is based on the notion that, while the quality of the predictions obtained from the intermediate layers is not generally expected to be as high as the output from the final layer, these intermediate predictions nonetheless provide extremely useful information. Specifically, due to the gradual improvement across model layers, it has been found herein that additional information can be gleaned from the contrast between final and intermediate layers during inference. For instance, by shedding light on which predictions might be less trustworthy, the intermediate predictions can be used to actually strengthen the overall model output. For instance, combining (i.e., aggregating) the output from one or more intermediate layers with that of the final layer, while giving a lower score to the output from the intermediate layer(s) (see below), will enhance the resulting aggregated output by demoting those (less-trustworthy) predictions supported by the intermediate layer(s).

Reference may be made herein to predictions of the machine learning model ‘amateur’ and ‘expert.’ For instance, in the above scenario, the predictions made by the intermediate and final layers of the machine learning model may be thought of as those supported by the amateur and the expert, respectively. In that regard, the present techniques leverage the notion that it might be beneficial to prefer predictions to which only the expert assigns a high probability, versus predictions to which both the expert and the amateur assign high probabilities. Intuitively, since the amateur has a stronger propensity than the expert for problematic behaviors (e.g., repetitiveness in the case of text generation), such behaviors can be diminished by demoting predictions that are strongly supported by the amateur.

This scenario involves a balance. On the one hand, when making a prediction in a relatively simpler context, one would expect both the expert and amateur to be highly confident about the prediction. In contrast, when both the expert and amateur assign very low likelihoods to a certain prediction, these prediction probabilities may be uninformative. Thus, the aim of considering the predictions of the amateur during inference is to better inform a choice between a set of relatively plausible predictions given an input. Doing so leverages the notion that the sub-optimal predictions of intermediate hidden layers carry additional information, which can be utilized during inference to obtain more desirable predictions. In other words, the predictions of the amateur can serve as a tiebreaker of sorts, helping to highlight which out of a set of plausible alternative predictions is more ‘expert-like’ and less ‘amateur-like.’ As will be described in detail below, the present autocontrastive decoding approach can be employed to redistribute a given model's prediction probability distribution for the next token, by maximizing the difference between the log-probabilities of the final layer and those of the at least one intermediate hidden layer.

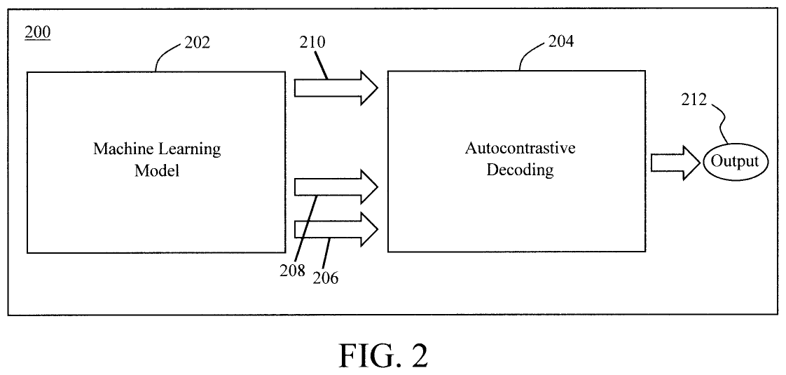

FIG. 2 is a diagram illustrating an exemplary configuration of system 200. As shown in FIG. 2, system 200 can include a machine learning model 202 and an autocontrastive decoding module 204 configured to obtain and aggregate output from multiple, different layers of the machine learning model 202 in a contrastive manner.

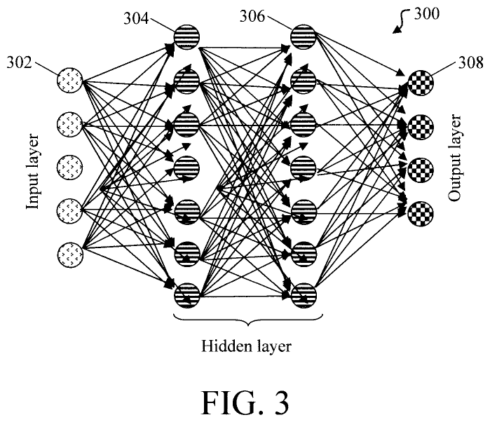

In general, machine learning model 202 can be any type of machine learning model having multiple layers of computation (also referred to herein as a ‘multi-layer machine learning model) such as, but not limited to, a neural network. For illustrative purposes only, a general fully-connected feed-forward neural network 300 is shown in FIG. 3. Referring briefly to FIG. 3, neural network 300 includes a plurality of interconnected processor elements 302, 304/306 and 308 that form an input layer, at least one hidden intermediate layer, and a final (output) layer, respectively, of the neural network 300. The connections in neural networks that carry electronic messages between simulated neurons are provided with numeric weights that correspond to the strength or weakness of a given connection. These numeric weights can be adjusted and tuned based on experience, making neural networks adaptive to inputs and capable of learning. Typically, neural networks are trained on labeled sets of training data. Once trained, the neural network can be used for inference. Inference applies knowledge from a trained neural network model and uses it to infer a result. A fully connected layer (typically the last or last few layers in a neural network) is a layer where all of the inputs from one layer are connected to every activation unit of the next layer. The fully connected layer(s) compile the data extracted by previous layers of the neural network to form the final output. According to an exemplary embodiment described in detail below, the machine learning model 202 is a transformer-based machine learning model. A transformer-based machine learning model is a neural network that learns context and meaning by tracking relationships in sequential data, such as the sequence of words in a sentence.

Referring back to FIG. 2, arrows 206, 208 and 210 are used to indicate that autocontrastive decoding is performed on output from multiple, different layers of the machine learning model 202. For instance, according to an exemplary embodiment, autocontrastive decoding module 204 aggregates, in a contrastive manner, the output from one or more intermediate layers of the machine learning model 202 (see, e.g., arrows 206 and/or 208) with the output from the final layer of the machine learning model 202 (see, e.g., arrow 210). As highlighted above, the autocontrastive decoding module 204 leverages the less-informative predictions of the intermediate layers of the machine learning model 202 (as compared to those of the final layer) to provide a final output 212 from system 200 that is better informed than those based on the final layer output alone.

Namely, according to an exemplary embodiment, the output from the intermediate layers of the machine learning model 202 is aggregated (i.e., combined) with the output from the final layer of the machine learning model 202, while giving a lower score to the output from the intermediate layers of the machine learning model 202 as compared to the output from the final layer of the machine learning model 202. To look at it another way, the present contrastive aggregation process demotes the (less-informative) predictions supported by the intermediate layer(s).

It is notable that, in accordance with the present techniques, the output from one or more of the intermediate layers of the machine learning model 202 can be leveraged for autocontrastive decoding vis-à-vis the output from the final layer of the machine learning model 202. Thus, embodiments are contemplated herein where the outputs from multiple intermediate layers of the machine learning model 202 are obtained and aggregated in a contrastive manner with the output from the final layer of the machine learning model 202. Embodiments are also contemplated herein where the output from a single intermediate layer of the machine learning model 202 is obtained and aggregated in a contrastive manner with the output from the final layer of the machine learning model 202.

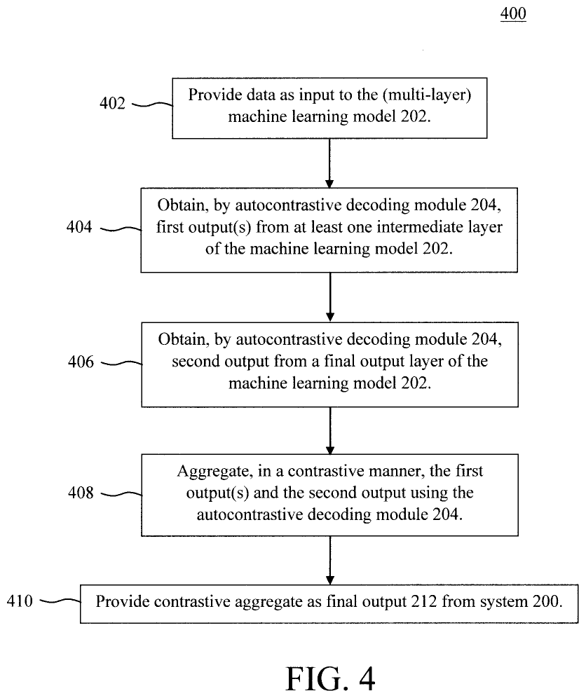

FIG. 4 is a diagram illustrating an exemplary methodology 400 for machine learning that may be performed using the present system 200. In step 402, data is provided as input to the (multi-layer) machine learning model 202. According to an exemplary embodiment, the machine learning model 202 is a transformer-based machine learning model. An example implementing a transformer-based machine learning model for natural language processing is described in detail below.

Predictions from multiple, different layers of the machine learning model are then obtained by the autocontrastive decoding module 204 as the data propagates through the machine learning model 202. For instance, using the above example where the machine learning model 202 architecture includes a plurality of intermediate layers and a final output layer, in step 404 first prediction probabilities are obtained as output from at least one of the intermediate layers. Namely, as highlighted above, the first prediction probabilities obtained in step 404 can be that of a single intermediate layer, or a collection of multiple first prediction probabilities obtained as output from more than one of the intermediate layers. In choosing which intermediate layer(s) to extract the first prediction probabilities from, the criteria are that the first prediction probabilities of the intermediate layer(s) chosen are on the one hand expected to be sufficiently different from that of the final output layer (see below), while on the other hand are of high enough quality to be useful points of contrast (as extremely low-quality predictions would be uninformative). Leveraging predictions from multiple intermediate layers can have the advantage of providing more confidence that what is being observed is a consistent process and not just random noise. For instance, if it is seen that the probability by the final output layer F is higher than some intermediate layer I1, there is lower level of confidence that this is a meaningful observation, and not just an artifact. However, if the predictions of another intermediate layer I2 are also provided, and it is observed that I1<I2<F, then there is a higher level of confidence that this change provides useful information about the gradual improvement process within the model.

In step 406, second prediction probabilities are obtained as output from the final output layer of the machine learning model 202. By way of steps 404 and 406, the autocontrastive decoding module 204 leverages the output obtained by passing the data through a fewer number of the layers of machine learning model 202 (e.g., from one or more of the intermediate layers), as well as the output obtained by passing the data through a larger number of the model layers (e.g., propagating the data through all of the layers), respectively.

In step 408, the first prediction probabilities obtained from at least one of the intermediate layers of the machine learning model 202 (step 404) and the second prediction probabilities obtained from the final output layer of the machine learning model 202 (step 406) are aggregated in a contrastive manner by the autocontrastive decoding module 204. For instance, according to an exemplary embodiment, a lower score is given to the first prediction probabilities obtained from at least one of the intermediate layers as compared to the second prediction probabilities obtained from the final output layer of the machine learning model 202. Namely, as will be described in detail below, while predictions are obtained from all of the layers in the machine learning model, i.e., as the second prediction probabilities obtained from the final output layer, the probabilities (scores) of those second prediction probabilities are changed (increased/decreased) according to the probabilities of the predictions of the intermediate layer(s).

In step 410, the (contrastive) aggregate from step 408 is provided as the final output 212 from system 200. This final output 212 can be used to perform downstream tasks, such as making word predictions. Notably, as provided above, using the less-informative predictions of the intermediate layers of the machine learning model 202 to supplement those of the final layer in this manner advantageously serves to provide a final output 212 that is better informed than what could be obtained using the final layer output alone. Namely, the knowledge gleaned by the present contrastive aggregation process helps to identify and avoid those (less-informative) predictions supported by the intermediate layer(s).

According to one exemplary embodiment contemplated herein, the machine learning model 202 is a transformer-based machine learning model. Transformer-based machine learning models can be used for a variety of applications including, but not limited to, natural language processing tasks such as text generation. For instance, transformer-based language model can take text such as a sequence of words as input, and predict what the next word in that sequence might be in order to form a grammatically and semantically correct sentence.

A transformer-based machine learning model is an ideal candidate for the present contrastive approach. Namely, the final prediction (distribution) from a transformer-based machine learning model is constructed in a bottom-up manner and, it has been found herein, that due to the gradual improvement across model layers additional information can be gleaned from the contrast between higher and lower layers during inference. The terms ‘higher’ and ‘lower’ as used herein refer to the layers along the path of this bottom-up data propagation through the stack of transformer-based machine learning model layers. For instance, the lower layers of a transformer-based machine learning model may be considered as the intermediate layers referred to above. In that case, the final layer referred to above is a higher layer, relative to the intermediate layers.

Specifically, in choosing between the probable next token predictions of a generative model such as a transformer-based machine learning model, the predictions of lower layers can be used to highlight which candidates are best avoided. Tokenization is the process of dividing data (in this example text) into smaller parts such as individual words, phrases, etc. which are referred to herein as tokens. Advantageously, as will be described in detail below, utilizing the contrast between transformer-based machine learning model layers improves text generation outputs, and mitigates degenerative behaviors of the model in open-ended generation, significantly improving the quality of generated texts. Furthermore, it has been found herein that contrasting between model layers at inference time can yield substantial benefits to certain aspects of general language model capabilities, more effectively extracting knowledge during inference from a given set of model parameters.

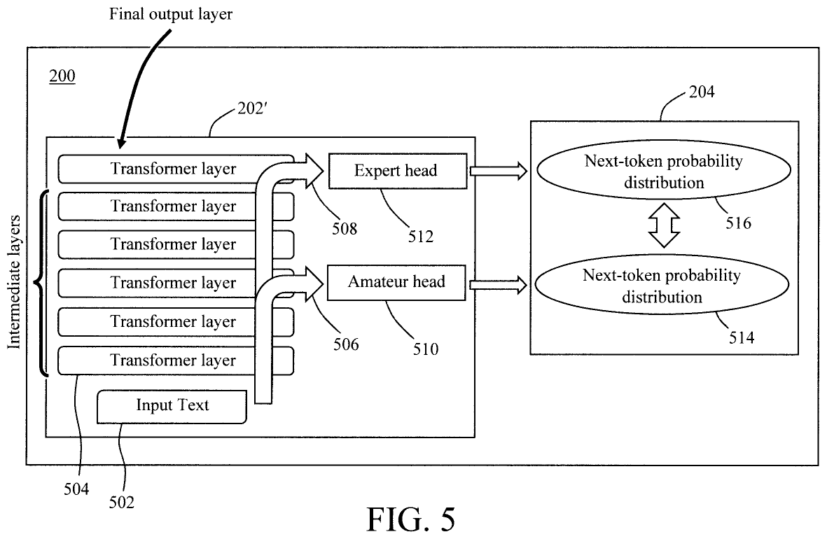

An exemplary configuration of the present autocontrastive decoding system 200 implementing a transformer-based machine learning model (here given the reference numeral 202′ for clarity) is shown illustrated in FIG. 5. Referring to FIG. 5, data (i.e., input text 502) is provided as input to the transformer-based machine learning model 202′, as per step 402 of methodology 400 above. As the data propagates through the various layers 504 of the transformer-based machine learning model 202′ (labeled ‘Transformer layer’), a (first) output is obtained from at least one intermediate one of the layers 504 (see arrow 506), as per step 404 of methodology 400 above. A (second) output is also obtained from final one of the layers 504 (see arrow 508), as per step 406 of methodology 400 above. As described above, data propagates through transformer-based machine learning model 202′ from the bottom-up.

According to an exemplary embodiment, the transformer-based machine learning model 202′ is a pre-trained language model designated as LM_{orig} and, as shown in FIG. 5, its final output layer is taken as the expert. The next-token probability distribution (e.g., next word prediction) of this final output layer is denoted as p_{EXP} (xₜ|x_{<t}), which is conditioned on the preceding context (xt being the next token to predict, and x_{<t} is the context that precedes it).

To obtain the amateur from transformer-based machine learning model 202′, a linear head is added to at least one of the intermediate hidden layers of transformer-based machine learning model 202′ (making it an exit layer) and thus making LM_{orig} a multi-exit model where predictions can be obtained at intermediate points in the model stack. In general, a language model head is a layer where the model output (a vector) is projected linearly to obtain a next token prediction from the model. Oftentimes, this linear language model head (or simply ‘linear head’) is applied at the final step of the model—as in linear Expert head 512 (or simply ‘Expert head 512’) at the Final output layer (see FIG. 5). Here, however, as shown in FIG. 5 a linear head (Amateur head 510) is also added to at least one of the intermediate layers.

This new linear Amateur head 510 (or simply ‘Amateur head 510’) maps the output of the intermediate layer, given a preceding context, to a probability distribution over the vocabulary for the next token, denoted as P_{AMA(x}_{ₜ}_{|x}_{_{<t}}). To train only this new Amateur head 510, all of the existing pre-trained weights of LM_{orig} are first frozen. The model is then trained by applying the same self-supervised objective that was used to pre-train LM_{orig}.

In this training, the goal is not to fully reproduce the original pre-training of LM_{orig}. Namely, since a relatively small number of parameters are being trained, less data can be used and fewer training steps can be performed. This reduced training can lead to certain disparities between the Amateur head 510 and the Expert head 512, as the latter was previously trained as part of the original LM_{orig} pre-training. Thus, in one exemplary embodiment, a new Expert head (not shown) is then also trained using an identical procedure as the one used to train the Amateur head in order to provide a more straightforward relation between the Amateur and Expert heads. Doing so, however, is not a requirement, and embodiments are contemplated herein where follow up training of a new Expert head is not performed.

As shown in FIG. 5, the autocontrastive decoding module 204 then aggregates, in a contrastive manner, the first and second outputs as per step 408 of methodology 400 above. According to an exemplary embodiment, this output aggregation involves contrasting a (first) next-token prediction probability distribution 514 of the Amateur head 510, i.e., P_{AMA(x}_{ₜ}_{|x}_{_{<t}}); with a (second) next-token prediction probability distribution 516 of the Expert head 512, i.e., p_{EXP}(xₜ|x_{<t}).

In one embodiment, a contrastive decoding adaptive plausibility constraint, [symbol] _{head}(x_{<t}), is implemented which is defined by:

$${𝒱}_{head} ( {x}_{< t} ) = \{ {x}_{t} ∈ 𝒱 : {p}_{EXP} ( {x}_{t} \vert {x}_{< t} ) \geq a {max}_{{x}_{t}^{′} ∈ 𝒱} {p}_{EXP} ( {x}_{t}^{′} \vert {x}_{< t} ) \} . \qquad ( 1 )$$

Given a preceding context x_{<t}, this contrastive decoding adaptive plausibility constraint selects a subset of plausible next tokens, out of the vocabulary [symbol] , whose probabilities are above a threshold. The threshold is a fraction α of the probability of the token with the highest probability in the vocabulary. The hyperparameter α is in the range [0,1], and it is set to 0.1 in the example presented herein below.

The score S(xₜ|x_{<t}) for a plausible xₜ, i.e., xₜ∈ [symbol] _{head}(x_{<t}), indicating its likelihood to be the next token given the context x_{<t}, is calculated by contrasting the prediction probabilities given to it by the Expert head 512 and by the Amateur head 510:

$$S ( {x}_{t} \vert {x}_{< t} ) = log {p}_{EXP} ( {x}_{t} \vert {x}_{< t} ) - log {p}_{AMA} ( {x}_{t} \vert {x}_{< t} ) . \qquad ( 2 )$$

It is notable that this contrastive score is only applied to the tokens in [symbol] _{head}(x_{<t}). This constraint serves an important purpose in that it helps avoid assigning high probabilities to very unlikely tokens, namely those for which p_{EXP} is very low. At the same time, where the Expert head 512 is highly confident about a single top prediction, the constraint helps ensure that p_{AMA} does not alter the final outcome. For instance, consider a scenario where the token with the maximum probability is assigned a very high probability, e.g., max_{x′}_{ₜ}_{∈} [symbol] p_{EXP}(x′ₜ|x_{<t})>0.9, and where p_{AMA} for this token is also quite high. In this scenario, while Equation 2 may give a very low contrast score S(x′ₜ|x_{<t}), this will be the only token that meets [symbol] _{head}(x_{<t}) (Equation 1), and thus it will nonetheless be selected as the next token despite its low score.

According to an exemplary embodiment, the probabilities of the rest of the tokens in the vocabulary (those not included in [symbol] _{head}(x_{<t})) are retained, keeping the distribution of the expert head:

$${S}_{ACD} ( {x}_{t} \vert {x}_{< t} ) = \{ \begin{matrix}S ( {x}_{t} \vert {x}_{< t} ) & if {x}_{t} ∈ {𝒱}_{head} ( {x}_{< t} ) \\ {p}_{EXP} ( {x}_{t} \vert {x}_{< t} ) & otherwise\end{matrix} . \qquad ( 3 )$$

This score function is further transformed into a probability distribution. The distribution of the Expert head 512 is split into two probability masses, i.e., one for the tokens in [symbol] _{head}(x_{<t}), and another for the tokens not included in [symbol] _{head}(x_{<t}). The former prediction probability mass distribution of transformer-based machine learning model 202′ is redistributed, weighted by the scores given to each token by Equation 2:

$${S}_{redist} ( {x}_{t} \vert {x}_{< t} ) = softmax ( S ( {x}_{t} \vert {x}_{< t} ) ) \cdot {\sum }_{{x}_{t}^{′} ∈ {𝒱}_{head} ( {x}_{< t} )} {p}_{EXP} ( {x}_{t}^{′} \vert {x}_{< t} ) . \qquad ( 4 )$$

As provided above, the scores assigned by Equation 2 maximize the difference between the log-probabilities of the final layer and those of the intermediate hidden layer(s) as obtained via the Expert head 512 and Amateur head 510, respectively.

Replacing S(xₜ|x_{<t}) with S_{redist}(xₜ|x_{<t}) in Equation 3, an auto-contrastive decoding prediction probability distribution p_{ACD} is obtained as:

$${p}_{ACD} ( {x}_{t} \vert {x}_{< t} ) = \{ \begin{matrix}{S}_{redist} ( {x}_{t} \vert {x}_{< t} ) & if {x}_{t} ∈ {𝒱}_{head} ( {x}_{< t} ) \\ {p}_{EXP} ( {x}_{t} \vert {x}_{< t} ) & otherwise\end{matrix} . \qquad ( 5 )$$

Auto-contrastive decoding prediction probability distribution p_{ACD} is a token-level probability distribution that is provided as the final output from system 200, as per step 410 of methodology 400 above.

Thus, as highlighted above, a lower score is given to the first output obtained from at least one intermediate one of the layers 504 as compared to the second output obtained from a final one of the layers 504. Using a simple, non-limiting example to illustrate this concept, assume for simplicity that transformer-based machine learning model 202′ can give four possible predictions: A, B, C or D, and assigns each of them a probability. In that case, there would be a distribution of four probabilities that sum to 1. Further, assume for instance that the expert probabilities are {A: 0.03, B: 0.47, C: 0.42, D: 0.08} and the amateur probabilities are (A: 0.001, B: 0.62, C: 0.29, D: 0.09}. As per Equation 1 above, the probability of A will not be changed because it is below the threshold. For B, C, D, Equation 2 above is used to obtain their contrast scores. Now, log(EXP)−log(AMA) is mathematically equivalent to log(EXP/AMA). What this means is that the contrast scores obtained reflect the ratio between EXP and AMA. Generally, the more EXP is larger than AMA, the higher the score, and vice versa. Thus, for B the score is log(0.47/0.62)=log(0.76)=−0.27, and for C the score is log(0.42/0.29)=log(1.45)=0.37.

In this example, the expert originally gave a higher probability to B than to C. But the score from Equation 2 above gives a much higher score to C than to B because of the score ratio with AMA. Thus, when redistributing the predictions of the EXP (as per Equations 3-5 above), the score of A will not change, the scores of B and D will go down because they are relatively more amateur-like, and the score of C will go up because it is less amateur-like.

The present techniques are further described by way of reference to the following non-limiting examples. To test the present autocontrastive decoding approach, experiments were conducted on open-ended text generation, as well as on general language modeling benchmarks, comparing various performance metrics with and without applying auto-contrastive decoding. In order to analyze changes in performance across model layers, multiple new linear exit heads were added to the models, and baseline model behavior at different exit layers was observed.

Two pre-trained auto-regressive transformer-based language models were used as test models for exploring multi-exit performance and the effects of autocontrastive decoding. Specifically, the pre-trained model checkpoints of a first model (Model I) having 355 million (M) parameters and 24 layers, and a second, smaller model (Model II) having 125 M parameters and 12 layers were used.

In the same manner as described above, multi-exit variants of these models were created, that were identical to the original pre-trained checkpoints, other than the newly-added parameters for several new linear exit heads. To present a more comprehensive analysis, multiple heads were added, i.e., one connected to each of the even-numbered layers. As such, a total of 12 and 6 exit heads were added to Model I and Model II, respectively. Each head used the same configuration as the original language modeling head, with outputs for the 50257 tokens in the vocabulary and an input size of 1024 (Model I) or 768 (Model II).

These heads were trained on language modeling using self-supervision over the English portion of a multilingual corpus, following a standard pre-training approach (see below for further details), while keeping the original model parameters frozen. As described above, the original pre-training regime is not precisely replicated when training the heads. Specifically, different pre-training data is used and training is done for a smaller number of training steps. Nevertheless, the quality of the training process was verified by comparing the performance of a newly-trained final layer exit head to that of the original exit head of the pre-trained model. which is described in detail below.

The pre-trained multi-exit base models were used as-is for open-ended text generation and for the benchmarks reported below. Model training and text generation were performed using an open-source transformers library and machine learning framework.

Open-ended text generation was evaluated in three domains: books, online encyclopedia, and news. Open-ended passage continuation was tested by using the first 32 words of a passage as a prompt, and using the multi-exit variant of the pre-trained model to decode up to 100 tokens.

Since autocontrastive decoding outputs a full probability distribution (see above), it can more naturally be combined with various existing decoding strategies. For instance, in the present evaluation, autocontrastive decoding was combined with the following existing decoding methods: a greedy decoder which selects the token having the highest probability, beam search (beam size of 5), top-k random sampling (k=50), and top-p portion sampling of the probability mass (p=0.95).

Generation quality was evaluated using automatic metrics focusing on different axes: aggregated n-gram textual diversity which measures the repetitiveness within the generated continuations, and semantic coherence which estimates topic drift by calculating similarity between the prompt and continuation. Human evaluation of the generation quality was also obtained, which compared a sample of generation results across different settings, as explained below.

The autocontrastive decoding-enhanced model was evaluated as a pre-trained language model, according to benchmarks that are commonly used to measure language modeling capabilities. For instance, a first benchmark (Benchmark I) was used that is tailored to evaluating capabilities of computational language models for text understanding by means of a word prediction task. Benchmark I is a popular benchmark that was proposed to encourage computational language models to keep track of information in the broader discourse, rather than paying attention to local context only. It has been shown that language models which exploit the context in a shallow manner perform poorly on this benchmark. It is thus a relevant measure of more advanced language understanding abilities.

A second benchmark (Benchmark II) typically employed for reporting progress in language modeling uses the inverse of the (geometric) average probability assigned to each word in the test set by the model. Benchmark II is commonly used as a measure of model quality, due in part to its simplicity and its relation to the maximum likelihood framework. An open-source library was used for running the benchmark tests.

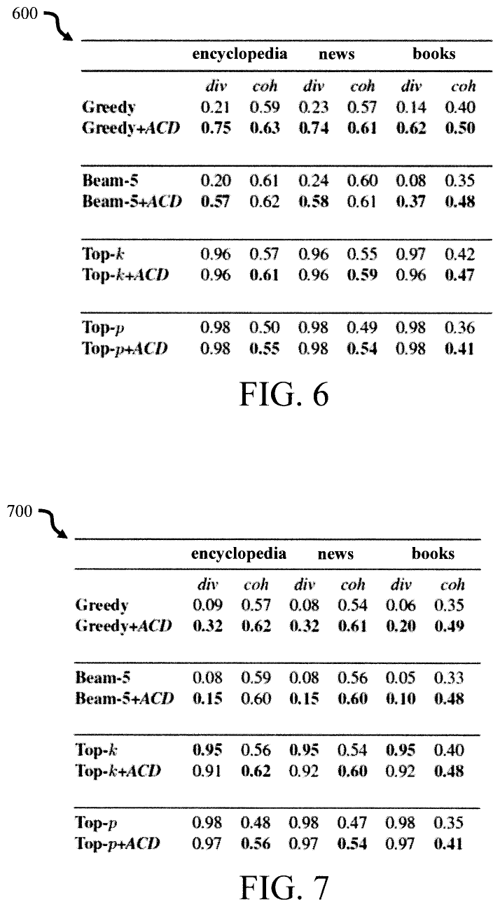

Results for open-ended text generation for Model I are shown in table 600 of FIG. 6. Namely, table 600 lists the automatic quality metrics of n-gram textual diversity (div) and topic coherence with the prompt (coh) of pretrained Model I, using different decoding strategies. For each strategy, results are compared using the probability distribution of the exit head of the final (24th) model layer, to those obtained using an autocontrastive decoding probability distribution, contrasting the final layer next-token predictions with those of exit layer 12. For the greedy and beam-search strategies, which exhibit low textual diversity of generated texts, a significant improvement in textual diversity is seen when combining them with the present autocontrastive decoding (ACD). At the same time, semantic coherence scores with autocontrastive decoding are higher in almost all settings tested.

Similar effects of autocontrastive decoding can be observed for the smaller Model II. See, for example, table 700 of FIG. 7. Namely, table 700 lists the automatic quality metrics of n-gram textual diversity (div) and topic coherence with the prompt (coh) of pretrained Model II, using different decoding strategies. For each strategy, results are compared using the probability distribution of the exit head of the final (12^{th}) model layer, to those obtained using an autocontrastive decoding probability distribution, contrasting the final layer next-token predictions with those of exit layer 8.

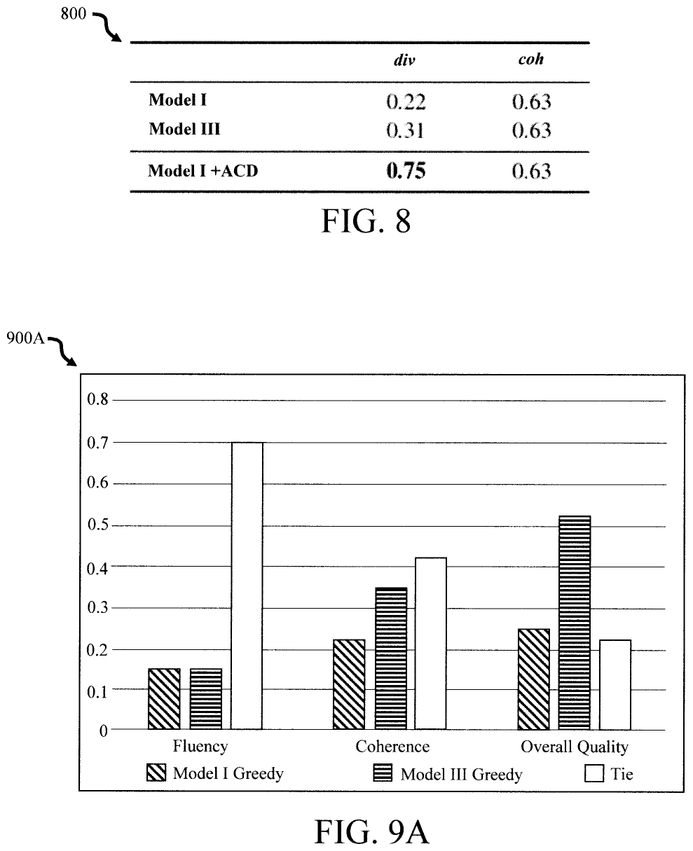

Given the dramatic performance boost given by autocontrastive decoding, as seen in tables 600 and 700, an evaluation of how autocontrastive decoding-enhanced generation outputs compare to those of a larger model with more advanced capabilities was done. To this end, open-ended generation was performed using a third model (Model III) having 1.5 billion (B) parameters. See table 800 of FIG. 8. Namely, table 800 depicts topic coherence (coh) and n-gram textual diversity (div) of generation outputs over an online encyclopedia corpus, for three settings: a large model (Model III, 1.5 B parameters), a medium-sized model (Model I, 355 M parameters, using its original exit head), and the same medium-sized Model I applying autocontrastive decoding at inference time, contrasting the next-token predictions of the final (24^{th}) layer and layer 12. As can be seen in table 800, Model I (355 M parameters) that is enhanced by autocontrastive decoding significantly outperforms its larger scale counterpart.

To verify that these results are robust and not an artifact of the automatic measures used, human evaluation of a sample of generation outputs from the results in table 800 was conducted, presenting the prompt and pairs of generated texts to human annotators and asking them to compare the quality of outputs. Results indicate that outputs from Model III were twice as likely to be judged as better compared to the baseline Model I. However, strikingly, Model I outputs obtained using autocontrastive decoding were overall judged as slightly better than those of the much larger Model III.

Specifically, two human evaluations for open-ended generation quality of the models were conducted, one comparing greedy decoding outputs of Model I and Model III, and the other comparing greedy decoding outputs of Model III to Model I with autocontrastive decoding (ACD). As input for inference, 40 texts from the online encyclopedia dataset were randomly sampled. Following the setting described above, the first 32 words of those texts were used as prompts and for each evaluated model up to 100 tokens of the decoded text were extracted. The same prompts were used for the two sets of evaluations, and thus also identical generation outputs of the Model III Greedy setting.

Three natural language processing experts labeled the 80 resulting instances, consisting of a prompt and inferences from two models. For each instance, they were asked to select the better model on three different aspects, in separate questions: fluency, coherence and overall quality. For each question they could select either ‘model A’, ‘model B’ or a tie. The inferences were shuffled such that ‘model A’ for each displayed instance was randomly selected from either the Model III Greedy model or its counterpart. The sets of evaluations (i.e., Model III vs. Model I and Model III vs. Model I+ACD) were also shuffled, such that annotators did not know which pair of models they were annotating.

The final label for each instance was obtained by the majority choice of the annotators. A tie majority label was achieved either when the majority of annotations was tie or when no majority was obtained (which in this setting could only occur when annotations are equally distributed—one for each model and one tie).

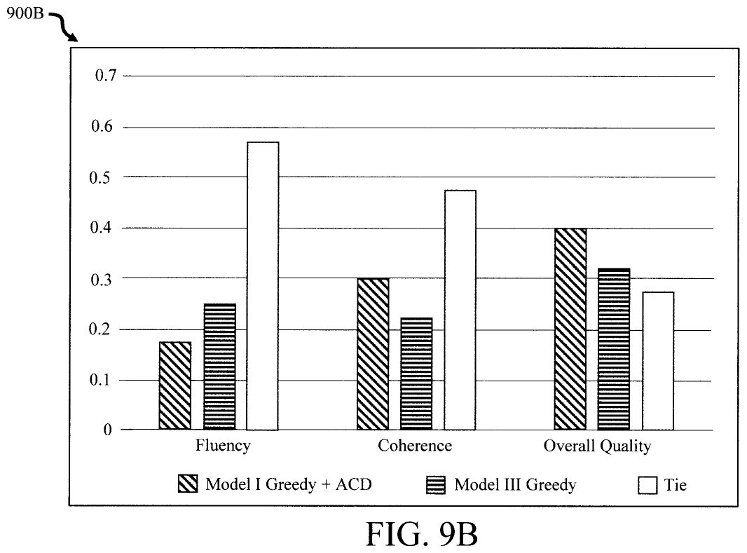

Label distributions are shown in FIGS. 9A and 9B. Namely, FIG. 9A is a plot 900A of human evaluation results comparing greedy decoding generation outputs of Model III and Model I. FIG. 9A shows the distribution of majority labels for each of the three task questions. FIG. 9B is a plot 900B of human evaluation results comparing greedy decoding generation outputs of Model III and Model I+autocontrastive decoding (ACD). FIG. 9B also shows the distribution of majority labels for each of the three task questions. Inter-annotator agreement for those tasks, obtained by averaging Cohen's Kappa coefficient κ for all annotator pairs, in each task, for each question was as follows—0.15 for the fluency question, 0.34 for the coherence question and 0.42 for the overall quality question.

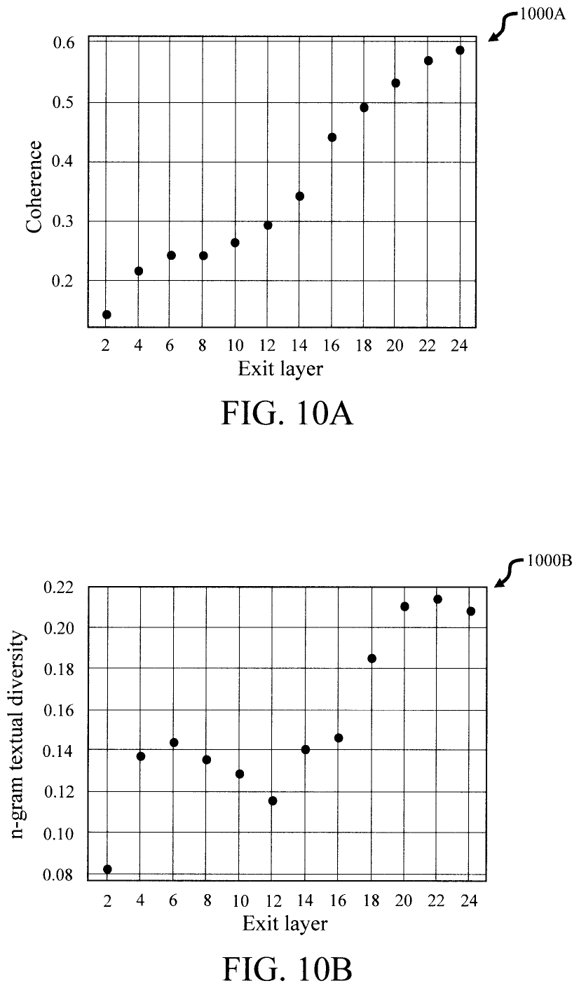

Plot 1000A in FIG. 10A portrays the behavior of the automatic coherence measure when relying on the outputs of different Model I exit layers. Each point represents an average over the online encyclopedia test examples of the coherence. It appears that the generation coherence, i.e., the semantic relatedness between the prompt and generated continuation, rises consistently as progressing from lower to higher layers. Presumably, this reflects a gradual decrease in topic drift behaviors and an increased ability to generate longer sequences that remain semantically coherent.

Plot 1000B in FIG. 10B depicts the n-gram textual diversity of open-ended generation across layers. Each point represents an average over the online encyclopedia test examples of the n-gram textual diversity. Interestingly, this measure exhibits more complex patterns, rising and falling going from lower to higher layers. As is common with automatic quality metrics for text generation, this is seen as an indication that n-gram repetition provides only a partial window into the generation quality, particularly where the textual diversity is overall quite low. Moreover, the nature of outputs may undergo phase shifts as they improve. For instance, generated sequences may shift from being diverse but unrelated to the inputs in lower layers, to texts that are semantically related to the prompt but highly repetitive, and so on.

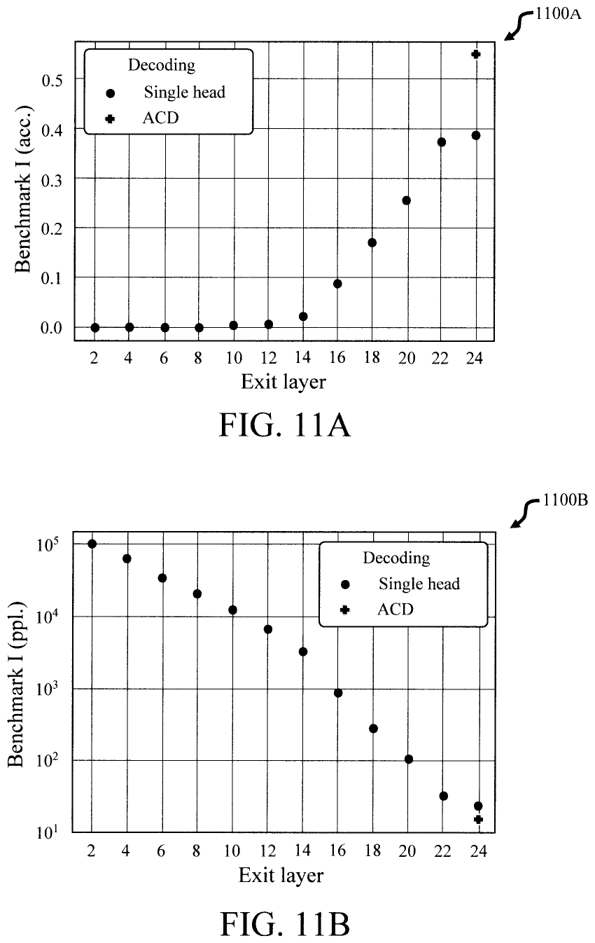

Results for the Benchmark I task, for individual exit layers of Model I and for autocontrastive decoding generation, are shown in FIGS. 11A and 11B. Specifically, FIG. 11A is a plot 1100A displaying accuracy (acc.) (higher is better) on Benchmark I, and FIG. 11B is a plot 1100B displaying perplexity (ppl.) (lower is better, presented in log scale) on Benchmark I across layers. Dots are used to denote individual Model I exit layers. Results for the autocontrastive decoding (ACD) probability distribution, contrasting layers 24 and 12, are denoted by a plus sign. The accuracy and the perplexity metrics of this benchmark dataset both improve as progressing along the model layers. In both cases, performance is further improved by applying autocontrastive decoding, with substantial gains in accuracy. This is a non-trivial finding in that it provides an indication that autocontrastive decoding use enables the model to more accurately take into account the broader context and long-range dependencies in the text.

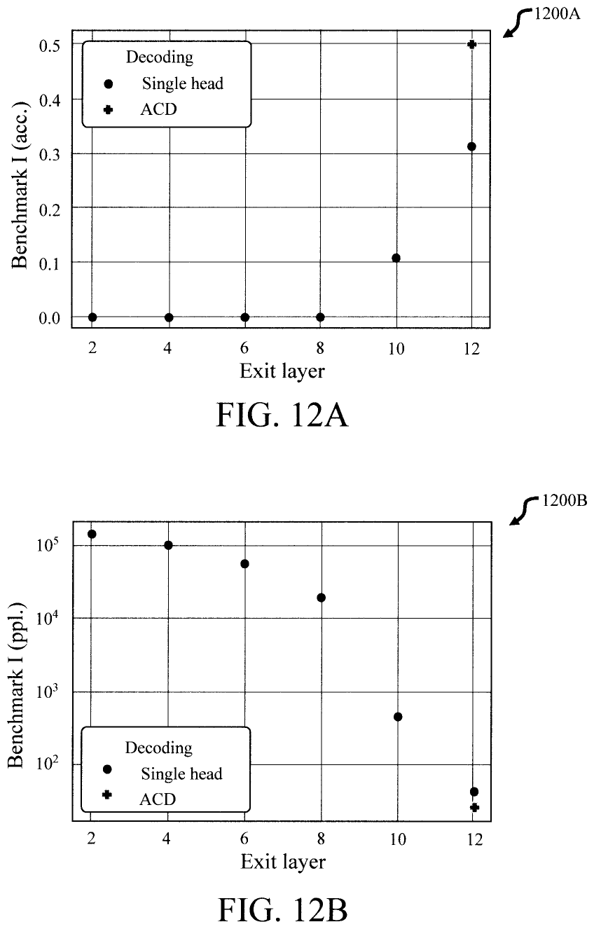

Similar gains are obtained for Model II. See FIGS. 12A and 12B. Specifically, FIG. 12A is a plot 1200A displaying accuracy (acc.) (higher is better) on Benchmark I, and FIG. 12B is a plot 1200B displaying perplexity (ppl.) (lower is better, presented in log scale) on Benchmark I language modeling task across different layers. Dots are used to denote individual Model II exit layers. Results for the autocontrastive decoding (ACD) probability distribution, contrasting layers 12 and 8, are denoted by a plus sign.

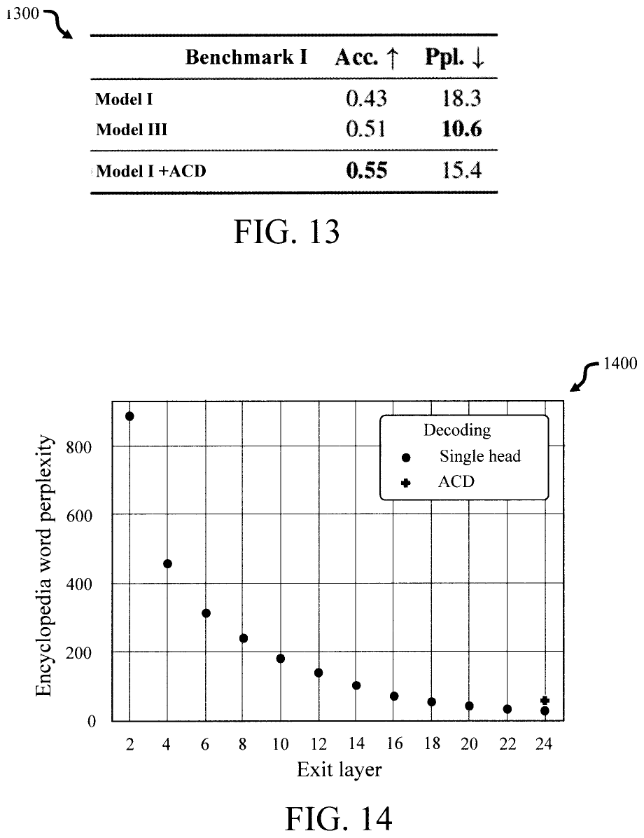

As above, it may be further inquired as to how these gains compare to the performance reached by a larger pre-trained model. In that regard, reference is made to table 1300 of FIG. 13 which displays the scale effects of autocontrastive decoding on the Benchmark I dataset. Table 1300 depicts the accuracy (acc.) and perplexity (ppl.) scores of the Benchmark I for three settings the large model (Model III, 1.5 B parameters), the medium-sized model (Model I, 355 M parameters, using its original exit head), and the same medium-sized Model I applying autocontrastive decoding (ACD) at inference time, contrasting the next-token predictions of the final (24^{th}) layer and layer 12. As shown in table 1300, Model I enhanced by autocontrastive decoding is on par with the larger Model III (1.5 B parameters) on the Benchmark I, achieving improved accuracy. Thus, autocontrastive decoding provides a substantial benefit for the challenging Benchmark I data, that specifically measures a model's advanced ability to look at broader context windows.

FIG. 14 is a plot 1400 depicting the word-level perplexity (lower is better) over the general online encyclopedia benchmark dataset. Dots are used to denote individual Model I exit layers. Results for the autocontrastive decoding (ACD) probability distribution, contrasting layers 24 and 12, are denoted by a plus sign. As can be seen in plot 1400, perplexity behaves as expected across model layers.

As the above examples illustrate, the present approach to contrast different model layers improves the output probabilities of a generative model. Namely, applying it to existing pre-trained language models demonstrates that intermediate low-performing model layers can inform the predictions of the high-performance final layer. This setting is of particular interest due to its practicality and flexibility, as it can be applicable to models of different sizes and is utilized during inference via a single forward pass.

More broadly, however, the present findings suggest that one would be able to make more out of an existing model simply by considering the predictions of intermediate layers (which are typically ignored). This idea is somewhat counterintuitive, as language models are in a sense optimized-and often in a long pretraining process over massive corpora-for the quality of their final layer representations. At the same time, thematically this notion is in line with works that describe the computations in transformer models as a linear-like progression, where each layer refines the representations of the previous ones, and where even the representations of specific tokens can shift in a consistent direction along with the progression across layers. Thus, if the changes from one layer to the next can track a vector of improvement with a discernible direction then this vector could be extended and, in doing so, help estimate what a larger model, with additional layers, would have said about a particular instance.

Details of the pre-training used in the above examples are now provided. For training the additional linear heads in the presently tested multi-exit versions of Model I and Model II a training regime was applied to the pre-trained models, while freezing the parameters of the original pre-trained model checkpoints in the manner described above.

For runtime considerations, all of the added linear heads were trained (12 and 6 heads in total for Model I and Model II, respectively) within a single training run, where a cross-entropy loss is calculated for the outputs of each individual linear head with respect to the labels, and the total training loss is calculated as the sum of these losses. Note that since each head is only connected to its exit layer m, and the shared pre-trained model parameters are kept frozen, this setup is roughly equivalent to training each of the linear heads separately.

Training was conducted with self-supervision over the English portion of the multilingual corpus, using 20 M instances out of the full dataset. Each text was tokenized, and the different tokenized instances were then joined together into chunks with a maximum sequence length of 512. Thus, no padding was applied to the examples. Following the tokenization and chunking, the training data consisted of ˜1.3 M training examples (˜650 M tokens). Training was performed using a causal language modeling objective, where the cross-entropy loss is calculated between the autoregressively generated outputs of the language modeling head and the input tokens (of length 512), which serve as the label.

The linear heads of each model were trained for 3 epochs over the chunked texts, using an adaptive optimizer, a learning rate of 2×10⁻⁴ with a linear decay scheduler, and a train batch size of 64. Training runs totaled approximately 24/55 GPU hours for Model II/Model I, respectively.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A system for machine learning, the system comprising:
a multi-layer machine learning model; and
an autocontrastive decoding module configured to obtain prediction probabilities from multiple, different layers of the multi-layer machine learning model as data propagates through the multi-layer machine learning model, and aggregate in a contrastive manner the prediction probabilities from the multiple, different layers of the multi-layer machine learning model to provide a final output from the multi-layer machine learning model.

2. The system of claim 1, wherein the multi-layer machine learning model comprises one or more intermediate layers and a final output layer.

3. The system of claim 2, wherein the autocontrastive decoding module is further configured to obtain first prediction probabilities from at least one of the intermediate layers, and obtain second prediction probabilities from the final output layer.

4. The system of claim 3, wherein the autocontrastive decoding module is further configured to aggregate the first prediction probabilities from at least one of the intermediate layers with the second prediction probabilities from the final output layer, while changing the second prediction probabilities from the final output layer according to the first prediction probabilities obtained from at least one of the intermediate layers.

5. The system of claim 1, wherein the multi-layer machine learning model comprises a transformer-based machine learning model.

6. The system of claim 5, wherein at least one of the intermediate layers comprises a linear amateur head, and wherein the final output layer comprises a linear expert head, making the transformer-based machine learning model a multi-exit model.

7. The system of claim 6, wherein the linear amateur head is configured to map an output of the at least one of the intermediate layers to a first next-token probability distribution, and wherein the linear expert head is configured to map an output of the final output layer to a second next-token probability distribution.

8. The system of claim 7, wherein the autocontrastive decoding module is further configured to contrast the first next-token probability distribution with the second next-token probability distribution to provide a token-level probability distribution as the final output from the transformer-based machine learning model.

9. A system for machine learning, the system comprising:
a transformer-based machine learning model; and
an autocontrastive decoding module configured to redistribute a prediction probability distribution of the transformer-based machine learning model by maximizing a difference between log-probabilities of a final layer and one or more intermediate layers of the transformer-based machine learning model.

10. The system of claim 9, wherein at least one of the intermediate layers comprises a linear amateur head, and wherein the final output layer comprises a linear expert head, making the transformer-based machine learning model a multi-exit model.

11. The system of claim 10, wherein the linear amateur head is configured to map an output of the at least one of the intermediate layers to a first next-token probability distribution, and wherein the linear expert head is configured to map an output of the final output layer to a second next-token probability distribution.

12. The system of claim 11, wherein the autocontrastive decoding module is further configured to contrast the first next-token probability distribution with the second next-token probability distribution to provide a token-level probability distribution for the transformer-based machine learning model.

13. A machine learning method, comprising:
providing data as input to a multi-layer machine learning model;
obtaining prediction probabilities from multiple, different layers of the multi-layer machine learning model as the data propagates through the multi-layer machine learning model; and
aggregating in a contrastive manner the prediction probabilities from the multiple, different layers of the multi-layer machine learning model to provide a final output from the multi-layer machine learning model.

14. The machine learning method of claim 13, wherein the multi-layer machine learning model comprises one or more intermediate layers and a final output layer.

15. The machine learning method of claim 14, further comprising:
obtaining first prediction probabilities from at least one of the intermediate layers; and
obtaining second prediction probabilities from the final output layer.

16. The machine learning method of claim 15, further comprising:
aggregating the first prediction probabilities from at least one of the intermediate layers with the second prediction probabilities from the final output layer, while changing the second prediction probabilities from the final output layer according to the first prediction probabilities obtained from at least one of the intermediate layers.

17. The machine learning method of claim 14, wherein the multi-layer machine learning model comprises a transformer-based machine learning model.

18. The machine learning method of claim 17, further comprising:
adding a linear head to at least one of the intermediate layers to make the transformer-based machine learning model a multi-exit model.

19. The machine learning method of claim 17, further comprising:
redistributing a prediction probability distribution of the transformer-based machine learning model by maximizing a difference between log-probabilities of the final output layer and at least one of the intermediate layers.

20. The machine learning method of claim 19, further comprising:
providing the prediction probability distribution of the transformer-based machine learning model which has been redistributed as the final output from the multi-layer machine learning model.
